(19) United States
(12) Patent Application Publication
(10) Pub. No.: US 2026/0217000 A1
(43) Pub. Date: Jul. 30, 2026

(54) METHOD OF PRODUCING A BUILDING PANEL AND A BUILDING PANEL

(71) Applicant: Välinge Innovation AB, Viken (SE)

(72) Inventors: Göran ZIEGLER, VIKEN (SE); Daniel SCIALANGA, HELSINGBORG (SE)

(73) Assignee: Välinge Innovation AB, Viken (SE)

(21) Appl. No.: 19/459,061

(22) Filed: Jan. 26, 2026

(30) Foreign Application Priority Data
Jan. 27, 2025 (SE) 25500687

(51) Int. Cl. B32B 21/08; B32B 3/30; B32B 21/02; B32B 27/10; B32B 27/36

(52) U.S. Cl. CPC B32B 21/08; B32B 3/30; B32B 21/02; B32B 27/10; B32B 27/36; B32B 2250/03; B32B 2260/028; B32B 2260/046; B32B 2307/718; B32B 2307/7265; B32B 2607/00

(57) ABSTRACT

A method for producing a building panel is provided. The method comprises providing a substrate (1), applying a sub-layer (2) comprising a no added formaldehyde (NAF) binder (6a) on a front surface (4) of the substrate (1), wherein said NAF binder (6a) is a thermosetting binder, applying a paper layer (3) on the sub-layer (2), wherein said paper layer (3) is essentially unimpregnated when applied on said sub-layer (2), and thereafter applying heat and pressure to the paper layer (3), the sub-layer (2) and the substrate (1), thereby at least partially impregnating the paper layer (3) with the NAF binder (6a) of the sub-layer (2) and at least partially curing the NAF binder (6a) of the sub-layer (2), to form said building panel. A building panel produced with the method is also provided.

### CROSS REFERENCE TO RELATED APPLICATIONS

The present application claims the benefit of Swedish Application No. 2550068-7, filed on Jan. 27, 2025. The entire contents of Swedish Application No. 2550068-7 are hereby incorporated herein by reference in their entirety.

### TECHNICAL FIELD

The present disclosure relates to a method of producing a building panel, such as a floor panel, and to such building panel.

### TECHNICAL BACKGROUND

Several technologies are used to provide a floor panel, which is an imitation of a solid floor panel. The reason is that imitations may be produced more cost efficiently and a floor with a separate layer attached to a core of for example HDF or plywood is more moisture stable than solid wood floors.

Wood fiber based direct pressed laminated flooring usually comprises a core of a fiber board, an upper decorative surface layer of laminated paper and a lower balancing layer of laminate, plastic, paper or like material.

A laminate surface generally comprises two paper sheets, a printed decorative paper and a transparent overlay intended to protect the decorative paper from abrasion. The transparent overlay, which is made of refined fibers (e.g. a-cellulose fibers), comprises small hard and transparent aluminum oxide particles. The refined fibers are rather long, about 2-5 mm and this gives the overlay paper the required strength. In order to obtain the transparency, all natural resins that are present in the virgin wood fibers, have been removed and the aluminum oxide particles are applied as a very thin layer over the decorative paper. The surface layer of a laminate floor is characterized in that the decorative and wear properties are generally obtained with two separate layers one over the other.

The printed decorative paper and the overlay are generally impregnated with melamine-formaldehyde resin and laminated to a wood fiber-based core under heat and pressure.

The wear layer could also be produced without a cellulose overlay. In such a case melamine-formaldehyde resin and aluminium oxide particles are applied as a lacquered layer directly on the decorative paper with similar methods as described above. Such a wear layer is generally referred to as liquid overlay.

Recently new “paper free” floor types have been developed where powder technology is used to obtain a solid laminate surface comprises a substantially homogenous mix of non-processed wood fibres, binders and wear resistant particles. Such floor types may be referred to as “solid laminate floors.” The wear resistant particles are preferably aluminium oxide particles, silica or silicon carbide, and the binders are preferably thermosetting resins such as melamine-formaldehyde. In general, all these materials are preferably applied in dry form as a mixed powder on a HDF core and cured under heat and pressure to a 0.2-1.0 mm solid (opaque) laminate layer. The solid layer in solid laminate floors provides high impact and wear resistance.

Powder technology is also used to produce floors with a surface that combines the paper technology and powder technology. Such floor types may be referred to as “wood powder laminate floors” A decorative paper is applied on a sub layer comprising wood powder and binders. The decorative paper is protected by a conventional overlay. The main advantages with such floors are that deep embossing and improved impact resistance could be obtained, in combination with the desired décor.

WO2013/032387 discloses a method to impregnate a paper sheet from below by means of a powder based sub-layer comprising wood fibres and a thermosetting resin.

The binder of the powder based sub-layer described in WO2013/032387 is e.g. a formaldehyde-based binder, e.g. a melamine formaldehyde-based binder. Melamine-formaldehyde binders are robust and highly durable thermosetting binders, that are vastly used within the flooring industry. A problem is that both formaldehyde and melamine are considered harmful. Melamine is listed on the candidate list under REACH (the European registration, evaluation, authorization, and restriction of chemicals), and formaldehyde is known to be carcinogenic to humans and harmful to the environment and is under increased legislative pressure. Formaldehyde emissions from flooring products may be a problem for workers during manufacturing, also, emissions from finished floorings may sometimes be considered as a health risk to consumers. The growing environmental concerns and stringent legislative requirements to the formaldehyde emissions from wood-based panels poses new challenges to researchers and the industry, related to the development of sustainable, eco-friendly wood-based panels, with very low formaldehyde emission.

One solution to the problem is to use binders with no added formaldehyde (NAF binders). However, it has proven to be challenging to produce a building panel with a powder sub-layer and a decorative paper with acceptable surface quality parameters, without using any binder comprising formaldehyde.

From the above it is understood that there is room for improvements, and the present disclosure aims to solve or at least mitigate the above and other problems.

### SUMMARY

An overall objective of embodiments of the present disclosure is to provide an improvement over the above-described techniques and known art.

It is an objective of at least embodiments of the present disclosure to provide an improved method for producing a building panel comprising a no added formaldehyde (NAF) binder and an unimpregnated paper, and such a building panel.

In a first aspect, a method for producing a building panel is provided. The building panel may preferably be, or form part of, a floor panel, a ceiling panel, a wall panel, a door panel, a furniture component, a worktop, skirting boards, moldings, edging profiles or similar.

The method comprises providing a substrate, applying a sub-layer comprising a no added formaldehyde (NAF) binder on a front surface of the substrate, applying a paper layer on the sub-layer, wherein said paper layer is essentially unimpregnated when applied on said sub-layer, and thereafter applying heat and pressure to the paper layer, the sub-layer and the substrate, thereby at least partially curing the NAF binder of the sub-layer to form said building panel. The NAF binder of the sub-layer may preferentially be a thermosetting binder. The step of applying heat and pressure to the paper layer, the sub-layer and the substrate preferentially comprises at least partly impregnating the paper layer with the NAF binder of the sub-layer.

A no added formaldehyde (NAF) binder may be defined as a binder to which no formaldehyde or formaldehyde-containing composition has been added. However, as formaldehyde is found naturally in every living system, from plants to animals and humans, there may be trace amounts of formaldehyde present also in a NAF binder. Such trace amounts may be less than 0.5 wt. %, such as less than 0.1 wt. % or such as less than 0.01 wt. %.

The NAF binder of the sub-layer may additionally be a no added melamine (NAM) binder. This is advantageous as melamine is listed on the candidate list under REACH (the European registration, evaluation, authorization and restriction of chemicals), and the use of it is likely to be restricted in the future.

The NAF binder of the sub-layer may comprise one or more of polyester, unsaturated polyester, epoxy, polyurethane, acrylate, natural polymers such as lignin, or a combination thereof.

The sub-layer may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN) in the sub-layer

The sub-layer may comprise one or more of fillers, pigments, wear-resistant particles, lignocellulosic materials, such as wood-fibers, and other additives. The wood-fibers may preferably be made from recycled wood or wood waste. The wood-fibers may come from post-consumer waste or post-industrial waste of wood building panels such as furniture, flooring or building elements. The wood waste may come from various wood handling processes such as furniture, flooring, or building production processes. The lignocellulosic materials may also be one or more of hemp, grass, flax, straw and/or bagasse.

The sub-layer may comprise 0-60% by weight of lignocellulosic materials.

The sub-layer may comprise 0-90% by weight of inorganic fillers, such as calcium carbonate, barium sulphate, silicon dioxide, kaolin, talc, wollastonite and/or pigments.

The sub-layer may comprise 10-100% by weight of NAF binder, such as 20-100% by weight or 50-100% by weight.

The sub-layer may comprise less than 50% by weight, such as less than 10% by weight, less than 5% by weight or less than 1% by weight of formaldehyde or a formaldehyde-comprising composition.

The sub-layer may be substantially free from formaldehyde.

The sub-layer may be substantially free from melamine.

The sub-layer may be applied as a powder, as a granulate, as a sheet, as a film, as a foil and/or in liquid form.

Generally herein, a powder refers to a material composed of fine, loose particles. If applied in powder form, the surface area of the particles may be maximized, and chemical reactions may occur faster and more effectively. A granulate herein refers to powder particles that are agglomerated into larger, free-flowing particles. The powder particles inside the agglomerated, larger, free-flowing particles may have the same size as the powder particles in powder form. A granulate may be easier to handle than a powder. The risk for segregation of different kinds of particles within a mixture may be reduced if the mixture is applied as a granulate. The risk for dust formation may be reduced if the mixture is applied as a granulate.

Generally herein, such as for the sheet, the granulate, and the powder, the sub-layer may have a moisture content of less than 5% by weight, such as less than 3% by weight, less than 2% by weight or 0-3% by weight, when applied on a front surface of the substrate. The sub-layer may have a moisture content exceeding 0% by weight and not exceeding 5% by weight, such as between 0.1% by weight and 5% weight, or between 0.1% by weight and 3% by weight, when applied on a front surface of the substrate.

The moisture content of the sub-layer when applied on the front surface of the substrate may refer to the moisture content of the sub-layer in the moment the sub-layer is applied on the front surface of the substrate.

The moisture content of the sub-layer when applied on the front surface of the substrate may alternatively refer to the moisture content of the sub-layer in the moment the substrate with the applied sub-layer enters the press.

The moisture content of the sub-layer may be controlled, for example by drying or applying water mist prior to applying the sub-layer on a front surface of the substrate.

The moisture content of the sub-layer may alternatively be controlled, for example by drying or applying water mist when the sub-layer has been applied on a front surface of the substrate. The moisture content of the sub-layer may be controlled in line.

Various drying techniques, such as for example IR radiation or convection heat may be used to dry the sub-layer.

The moisture content may refer to the water content.

The moisture content of the sub-layer may differ considerably compared to the moisture content of a sub-layer used to produce a corresponding laminate product made with a traditional formaldehyde-based binder, such as a melamine-formaldehyde binder. A formaldehyde-based binder may preferably have a moisture content of 15-25 wt % when applied on a substrate. If a sub-layer based on a NAF binder would have such a high moisture content, it might cause serious problems with blister formation when the building panel is formed.

The sub-layer may be applied in powder form. The applied powder may be a dry powder, such as a powder having a moisture content of less than 3% by weight such as less than 2% by weight or 1-3% by weight.

The sub-layer may be applied as a granulate.

The sub-layer may be applied in powder form and/or as a granulate.

The sub-layer may be applied as a sheet, preferably as an impregnated and/or coated sheet, such as an impregnated and/or coated paper. The coating and/or impregnation of the sheet may be made by heating a NAF binder in powder form and at least partially melting said NAF binder onto the surface of the sheet.

The sub-layer may be applied as a film or foil made from a suitable NAF binder.

The sub-layer may be applied in liquid form.

The sub-layer may be applied in an amount of 10-1000 g/m², such as 10-450 g/m² or 10-100 g/m².

The method may further comprise heating the sub-layer prior to applying the unimpregnated paper layer. Depending on the type and composition of the sub-layer, this may be beneficial and contribute to adhering the sub-layer to the substrate, which may result in a more reliable process.

The step of heating the sub-layer may comprise applying IR radiation, heat, microwaves, hot air and/or steam on the sub-layer. The step of heating may comprise pressing or hot rolling. By applying heat, e.g., in the form of IR radiation, a binder of the sub-layer applied in powder form may be at least partially transformed into fluid form or at least sintered so the particles in the powder stick together. The binder melts when applying heat exceeding the melting point of the binder, resulting in improved adhering of the sub-layer to the substrate. Another advantage is that the risk of the binder in powder form being displaced or partly displaced, for example due to mechanical influence, impact, vibrations or air flow, after being applied to the substrate is decreased. As a thermosetting binder is used, the sub-layer is not completely cured during the step of applying heat. It may be heated enough to form a film. The adhesive properties of the sub-layer remain after the step of heating the sub-layer.

The sub-layer may be heated without first applying moisture to the sub-layer or moisture may be applied to the sub-layer before the sub-layer is heated. Alternatively, other liquids, for example glycol, may be added to the sub-layer before it is heated, to increase adhesion of the sub-layer to the substrate.

The paper layer is essentially unimpregnated when applied on said sub-layer. By essentially unimpregnated is understood to mean free from added resin or substantially free from added resin, such as comprising less than 10 wt % of added resin, preferably less than 5 wt % of added resin, such as less than 2.5 wt % of added resin or less than 1 wt % of added resin. Any content of added resin in the unimpregnated paper layer prior to impregnation would typically come only from additives used in the papermaking process. The essentially unimpregnated paper layer may have a weight of 15-250 g/m², such as 15-200 g/m², 15-100 g/m² or 15-50 g/m².

The paper layer may comprise a decorative paper. The paper layer may comprise a print, such as a digital print or an analog print, such as of a wood grain pattern. The paper layer may be colored. The step of applying heat and pressure to the paper layer, the sub-layer and the substrate preferably comprises at least partially impregnating the paper layer with the NAF binder. This impregnation from below may be enough for impregnating the paper layer satisfactory.

The paper layer may be configured to form an upper surface of the finished building panel, facing upwards.

Laminate floorings could be produced with very advanced designs where a printed pattern is coordinated with an embossed structure of the surface. The embossing is made during lamination when the surface is pressed against a steel sheet with an embossed structure.

The depth of the embossing has earlier been limited because the paper layer could be damaged when the embossing is made with sharp edges or to a depth, which exceeds a few tenths of a millimeter. This problem is solved by incorporating the sub-layer between the substrate and the paper layer. The sub-layer can easily be compressed, formed and displaced in all directions during a part of a pressing operation until the binder cures. The uncured sub-layer behaves similar to a paste or a liquid substance and creates a uniform counter pressure in all parts under the paper layer even in surface parts of the paper with deep and sharp embossing. The result is an improved and easier forming with lower pressing force and improved surface quality. Embossed surfaces similar to a rough stone surface or a hand scraped wood surface or deep grooves that could be used to make bevels in a panel are possible to make with the presently disclosed method.

The step of applying heat and pressure may further comprise pressing the paper layer with an embossed pressing matrix, such that the paper layer obtains upper portions and embossed portions, lower than the upper portions, essentially by shaping of the sub-layer. The embossed pressing matrix may refer to an embossing pressing matrix. The embossed pressing matrix as well as the embossing matrix may provide an embossed surface.

The step of pressing the paper layer with the embossed pressing matrix may be by at least 0.1 mm, such as at least 0.2 mm or at least 0.5 mm. The method may comprise pressing the paper layer with the embossed pressing matrix by 0.1-1.0 mm, such as 0.1-0.8 mm or 0.1-0.7 mm.

The method may further comprise applying a backing layer to a back surface of the substrate opposite the front surface on which the sub-layer is applied, and thereafter applying heat and pressure to the paper layer, the sub-layer, the substrate and the backing layer, thereby at least partly curing the sub-layer and the backing layer to form said building panel.

The backing layer preferably comprises a NAF binder, such as a thermosetting NAF binder or a thermoplastic NAF binder. A NAF binder of the backing layer may comprise one or more of polyester, unsaturated polyester, epoxy, acrylate, natural polymers such as lignin or a combination thereof.

The backing layer may comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The NAF binder of the backing layer may additionally be a no added melamine (NAM) binder.

The backing layer may comprise one or more of fillers, pigments, wear-resistant particles, lignocellulosic materials, such as wood-fibers, and other additives. The wood-fibers may preferably be made from recycled wood or wood waste. The wood-fibers may come from post-consumer material, such as furniture, flooring or building elements. The wood waste may come from various wood handling processes such as furniture, flooring, or building production processes. The lignocellulosic materials may also be one or more of hemp, grass, flax, straw and/or bagasse.

The backing layer may comprise 0-60% by weight of lignocellulosic materials.

The backing layer may comprise 0-90% by weight of inorganic fillers, such as calcium carbonate, barium sulphate and/or silicon dioxide.

The backing layer may comprise 5-100% by weight of NAF binder, such as 20-100% by weight or 50-100% by weight.

The backing layer may comprise less than 60% by weight, such as less than 10% by weight or less than 5% by weight of formaldehyde or a formaldehyde-comprising composition

The backing layer may be substantially free from formaldehyde.

The backing layer may be substantially free from melamine.

The backing layer may be applied as a powder, as a granulate, as a sheet, as a film, as a foil and/or in liquid form.

Generally herein, such as for the sheet, the granulate, and the powder, the backing layer may have a moisture content of less than 5% by weight, such as less than 3% by weight, less than 2% by weight or 0-3% by weight, when applied on a back surface of the substrate. The backing layer may have a moisture content exceeding 0% by weight and not exceeding 5% by weight, such as between 0.1% by weight and 5% weight, or between 0.1% by weight and 3% by weight, when applied on a back surface of the substrate.

The moisture content of the backing layer when applied on the back surface of the substrate may refer to the moisture content of the backing layer in the moment the backing layer is applied on the back surface of the substrate.

The moisture content of the backing layer when applied on the back surface of the substrate may alternatively refer to the moisture content of the backing layer in the moment the substrate with the applied layers enters the press.

The moisture content of the backing layer may be controlled, for example by drying or applying water mist prior to applying the backing layer on a back surface of the substrate.

The moisture content of the backing layer may alternatively be controlled, for example by drying or applying water mist after applying the backing layer on a back surface of the substrate.

Various drying techniques, such as for example IR radiation or convection heat may be used to dry the backing layer.

The moisture content may refer to the water content.

The backing layer may be configured to form a lower surface of the finished building panel, facing downwards.

Known laminated building panels produced with a sub-layer comprising melamine-formaldehyde resin, requires a backing layer or balancing layer, provided on a surface of the substrate being opposite the surface on which the sub-layer is provided. The melamine-formaldehyde results in shrinkage, or contraction, forces acting on the building panel. Without the balancing layer, the product may be “cupping”, i.e., a first surface of the panel will shrink, the opposite surface will stretch correspondingly, resulting in a building panel with a concave cross section. Thus, a balancing layer is required to stabilize and/or balance the building panel in order to counteract those types of forces.

In order to provide balance, the balancing layer may preferably comprise the same layers as provided on the opposite side of the substrate, at least preferably comprise the same binder as provided on the opposite side of the substrate. Providing a balancing layer to the building panel makes the production more expensive. This is both due to material costs, but also a more complicated production process with an additional step of providing, handling, and storing the balancing layer. Also, when a panel is balanced by applying a balancing layer, internal tension may be created in the panel as the two surfaces of the panel are subject to contraction forces working in opposite directions. These internal tensions may even cause cracks in or delamination of the substrate.

Possible contraction forces due to the sub-layer may be too small to require balance in the form of a balancing or backing layer.

The method may not comprise a step of applying a backing layer to a back surface of the substrate opposite the front surface on which the sub-layer is applied.

There may however still be provided an optional backing layer, comprising e.g. a thin layer such as a lacquer, a varnish, an adhesive, a polymer-based sheet or foil, an impregnated paper or unimpregnated paper, a (colored) powder layer or a fabric, such as a woven or non-woven fabric.

The backing layer may be provided for informational, aesthetic, or decorative purposes.

The backing layer may be configured to form a moisture barrier. This is advantageous when the building panel is used as a floor panel and/or a building panel. Moisture from the base or foundation, such as a concrete ground, on which the building panel is applied may be transferred into the building panel. This may cause swelling of the building panel which may result in a deformed building panel. If the amount of swelling differs between the first and second surfaces of the building panel, the panel will be concave in cross section, i.e. the building panel will experience cupping. By applying e.g. a backing layer forming a moisture barrier, the transfer of moisture into the building panel causing swelling is limited. A backing layer configured to form a moisture barrier may comprise e.g. a thin layer such as a lacquer, a varnish, an adhesive, a polymer-based sheet or foil, an impregnated paper or a powder layer.

According to one example, the method may additionally comprise applying a surface layer on a front surface of the paper layer and thereafter applying heat and pressure to the surface layer, the paper layer, the sub-layer and the substrate, thereby at least partially curing the surface layer and the sub-layer to form said building panel.

The surface layer preferably comprises a NAF binder, more preferably a thermosetting NAF binder. The NAF binder of the surface layer may comprise one or more of polyester, unsaturated polyester, epoxy, acrylate, natural polymers, such as lignin, or a combination thereof.

The surface layer may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The NAF binder of the surface layer may additionally be a no added melamine (NAM) binder.

The surface layer may comprise one or more of fillers, pigments, wear-resistant particles, lignocellulosic materials, such as wood-fibers, and other additives. The wood-fibers may preferably be made from recycled wood or wood waste. The wood-fibers may come from post-consumer waste or post-industrial waste of wood building panels such as furniture, flooring or building elements. The wood waste may come from various wood handling processes such as furniture, flooring, or building production processes. The wood fibers may be virgin fibers. The lignocellulosic materials may also be one or more of hemp, grass, flax, straw and/or bagasse.

The surface layer may comprise 0-90% by weight of lignocellulosic materials.

The surface layer may comprise 0-50% by weight of inorganic fillers, for example wear resistant particles, such as aluminum oxide.

The surface layer may comprise 10-100% by weight of NAF binder, such as 20-100% by weight or 50-100% by weight.

The surface layer may comprise less than 50% by weight, such as less than 10% by weight, less than 5% by weight, or less than 1% by weight of formaldehyde or a formaldehyde-comprising composition.

The surface layer may be substantially free from formaldehyde.

The surface layer may be substantially free from melamine.

The surface layer may be applied as a powder, as a granulate, as a sheet, as a film, as a foil and/or in liquid form.

Generally herein, such as for the sheet, the granulate, and the powder, the surface layer may have a moisture content of less than 5% by weight, such as less than 3% by weight, less than 2% by weight or 0-3% by weight, when applied on a front surface of the paper layer. The surface layer may have a moisture content exceeding 0% by weight and not exceeding 5% by weight, such as between 0.1% by weight and 5% weight, or between 0.1% by weight and 3% by weight, when applied on a front surface of the paper layer. The moisture content of the surface layer when applied on the front surface of the paper layer may refer to the moisture content of the surface layer in the moment the surface layer is applied on the front surface of the paper layer.

The moisture content of the surface layer when applied on the front surface of the paper layer may alternatively refer to the moisture content of the surface layer in the moment the substrate with the applied sub-layer, paper layer and surface layer enters the press.

The moisture content of the surface layer may be controlled, for example by drying or applying water mist prior to applying the surface layer on a front surface of the paper layer.

The moisture content of the surface layer may alternatively be controlled, for example by drying or applying water mist after applying the surface layer has been applied on a front surface of the paper layer.

Various drying techniques, such as for example IR radiation or convection heat may be used to dry the surface layer.

The moisture content may refer to the water content.

The moisture content of the surface layer may differ considerably compared to the moisture content of a surface layer used to produce a corresponding laminate product made with a traditional formaldehyde-based binder, such as a melamine-formaldehyde binder. A formaldehyde-based binder may preferably have a moisture content of 15-25 wt % when applied on a substrate. If a surface layer based on a NAF binder would have such a high moisture content, it might cause serious problems with blister formation when the building panel is formed.

The surface layer may be applied in powder form. The applied powder may be a dry powder, such as a powder having a moisture content of less than 3% by weight such as less than 2% by weight or 1-3% by weight.

The surface layer may be applied as a granulate.

The surface layer may be applied in powder form and/or as a granulate.

The surface layer may be applied as a sheet, preferably as an impregnated and/or coated sheet, such as an impregnated and/or coated paper. The coating and/or impregnation of the sheet may be made by heating a NAF binder in powder form and at least partially melting said NAF binder onto the surface of the sheet.

The surface layer may be applied as a film or foil made from a suitable NAF binder.

The surface layer may be applied in liquid form.

The surface layer may be applied in an amount of 10-1000 g/m², such as 10-400 g/m² or 10-250 g/m².

The method may further comprise heating the surface layer prior to applying heat and pressure to the surface layer, the paper layer, the sub-layer and the substrate. The step of heating the surface layer may comprise applying IR radiation, heat, microwaves, hot air and/or steam on the surface layer. The surface layer may be heated without first applying moisture to the surface layer or moisture may be applied to the surface layer before the surface layer is heated. Alternatively, other liquids, for example glycol, may be added to the surface layer before it is heated, to increase adhesion of the surface layer to the paper layer. The surface layer may be configured to form an upper surface of the finished building panel, facing upwards.

The method may further comprise applying a backing layer to a back surface of the substrate opposite the front surface on which the sub-layer is applied, and thereafter applying heat and pressure to the surface layer, the paper layer, the sub-layer, the substrate and the backing layer, thereby at least partially curing the surface layer, the sub-layer, and the backing layer to form said building panel. The backing layer may be as disclosed above.

The step of applying heat and pressure may further comprise pressing the surface layer with an embossed pressing matrix, such that the surface layer obtains upper portions and embossed portions, lower than the upper portions, essentially by shaping of the surface layer and/or the sub-layer. The embossed pressing matrix may refer to an embossing pressing matrix. The embossed pressing matrix as well as the embossing matrix may provide an embossed surface.

The step of pressing the surface layer with the embossed pressing matrix may be by at least 0.1 mm, such as at least 0.2 mm or at least 0.5 mm. The method may comprise pressing the surface layer by 0.1-1.0 mm, such as 0.1-0.8 mm or 0.1-0.7 mm.

The NAF binder of the sub-layer, the NAF binder of the surface layer and/or the NAF binder of the backing layer may preferentially be a thermosetting binder, but the skilled artisan will appreciate that other binders, such as thermoplastic binders, are equally conceivable.

According to one alternative, the paper layer or the surface may be configured to form an outer surface of the finished building panel and the backing layer may be configured to form an inner or back surface of the finished building panel. The building panel may for example be a double-sided furniture component, such as a cabinet panel.

The substrate may be a wood-based board, such as an MDF board, a HDF board, a plywood, or a particle board.

Alternatively, the substrate may be a thermoplastic core, such as a filled thermoplastic core, such as a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel).

The substrate may be a mineral-based board, such as a board comprising magnesium oxide. The substrate may be a fiber-cement board, a gypsum board, a textile-based board or the like. The substrate may comprise a combination of different materials.

The step of heating and pressing may be performed by a continuous press.

The step of heating and pressing may be performed by a static press.

The pressure applied in the heating and pressing step may be at least 5 bar, such as at least 25 bar, preferably about 30-60 bar, or about 35-55 bar. The pressure may be applied during at least 10 s, preferably during 20-40 s. The temperature applied in the heating and pressing step may be 100-250° C., such as 160-220° C. A temperature of at least 150° C., such as at least 180° C., may be applied. The temperature may depend on which binder is used. Also, the temperature may depend on the speed of the production line in a continuous press or the press time of a static press.

After the step of heating and pressing the building panel may be surface treated such as with a UV-coating and/or a lacquer.

In a second aspect, a building panel produced with the method according to the first aspect is provided.

In addition to essentially eliminating the emission of formaldehyde during production of a building panel according to the first aspect, the emission of formaldehyde from the finished building panel is also essentially eliminated. It is an objective of embodiments of the present disclosure to provide a building panel comprising a thermosetting resin, wherein the emission of formaldehyde from the finished building panel is essentially eliminated, compared to known building panels comprising thermosetting resins.

In a third aspect, a building panel is provided. The building panel comprises a substrate, a sub-layer attached to a front surface of the substrate, and a paper layer attached to the sub-layer. The sub-layer comprises a thermosetting, no added formaldehyde (NAF) binder and the paper layer has been at least partially impregnated with the NAF binder of the sub-layer.

The paper layer may be configured to form an upper surface of the building panel, facing upwards.

The building panel may be a floor panel, a wall panel, a furniture component or similar.

The paper layer may comprise a decorative paper. The paper layer may comprise a print, such as a digital print or an analog print, such as of a wood grain pattern. The paper layer may be colored.

The paper layer may comprise embossed surfaces similar to a rough stone surface or a hand scraped wood surface or deep grooves that could be used to make bevels in a panel.

The paper layer may comprise upper portions and embossed portions lower than the upper portions.

The NAF binder of the sub-layer may be a thermosetting binder. The NAF binder of the sub-layer may comprise one or more of polyester, acrylate, natural polymers such as lignin or a combination thereof.

The NAF binder of the sub-layer may additionally be a no added melamine (NAM) binder.

The sub-layer may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The sub-layer may comprise one or more of fillers, pigments, wear-resistant particles, lignocellulosic materials, such as wood-fibers, and other additives. The wood-fibers may preferably be made from recycled wood or wood waste. The wood-fibers may come from post-consumer waste or post-industrial waste of wood building panels such as furniture, flooring or building elements. The wood fibers may be virgin fibers. The lignocellulosic materials may also be one or more of hemp, grass, flax, straw and/or bagasse.

The sub-layer may comprise 0-60% by weight of lignocellulosic materials.

The sub-layer may comprise 0-90% by weight of inorganic fillers, such as calcium carbonate, barium sulphate and/or silicon dioxide.

The sub-layer may comprise 10-100% by weight of NAF binder, such as 20-100% by weight or 50-100% by weight.

The sub-layer may comprise less than 50% by weight, such as less than 10% by weight or less than 5% by weight of formaldehyde or a formaldehyde-comprising composition

The sub-layer may be substantially free from formaldehyde.

The sub-layer may be substantially free from melamine.

The building panel may additionally comprise a surface layer arranged on a front surface of the paper layer. The surface layer may be configured to form an upper surface of the building panel, facing upwards.

The surface layer preferably comprises a NAF binder, more preferably a thermosetting NAF binder. The NAF binder of the surface layer may comprise one or more of polyester, unsaturated polyester, epoxy, acrylate, natural polymers such as lignin or a combination thereof.

The surface layer may additionally comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The NAF binder of the surface layer may additionally be a no added melamine (NAM) binder.

The surface layer may comprise one or more of fillers, pigments, wear-resistant particles, lignocellulosic materials, such as wood-fibers, and other additives. The wood-fibers may preferably be made from recycled wood or wood waste. The wood-fibers may come from post-consumer waste or post-industrial waste of wood building panels such as furniture, flooring or building elements. The wood waste may come from various wood handling processes such as furniture, flooring, or building production processes. The wood fibers may be virgin fibers. The lignocellulosic materials may also be one or more of hemp, grass, flax, straw and/or bagasse.

The surface layer may comprise 0-60% by weight of lignocellulosic materials.

The surface layer may comprise 0-50% by weight of inorganic fillers, for example wear resistant particles, such as aluminum oxide.

The surface layer may comprise 50-100% by weight of NAF binder, such as 20-100% by weight or 50-100% by weight.

The surface layer may comprise less than 50% by weight, such as less than 10% by weight or less than 5% by weight of formaldehyde or a formaldehyde-comprising composition

The surface layer may be substantially free from formaldehyde.

The surface layer may be substantially free from melamine.

The building panel may additionally comprise a backing layer arranged on a back surface of the substrate, opposite from the first surface on which the sub-layer is arranged.

The backing layer may comprise one or more of a binder, an essentially unimpregnated paper, an impregnated paper, a partially impregnated paper, a coated paper, or a combination thereof.

The backing layer preferably comprises a NAF binder, such as a thermosetting NAF binder or a thermoplastic NAF binder. The NAF binder may be at least partially cured in the finished building panel. The NAF binder of the backing layer may comprise one or more of polyester, unsaturated polyester, epoxy, acrylate, natural polymers such as lignin or a combination thereof.

The backing layer may comprise a thermoplastic NAF binder, such as polyesters, polyolefins, acrylates, methacrylates, styrenics, vinylacetates, vinyl alcohols, thermoplastic urethanes or combinations thereof. A thermosetting NAF binder and a thermoplastic NAF binder may form a semi-interpenetrating network (semi-IPN).

The NAF binder of the backing layer may additionally be a no added melamine (NAM) binder.

The backing layer may comprise one or more of fillers, pigments, wear-resistant particles, lignocellulosic materials, such as wood-fibers, and other additives. The wood-fibers may preferably be made from recycled wood or wood waste. The wood-fibers may come from post-consumer waste or post-industrial waste of wood building panels such as furniture, flooring or building elements. The wood waste may come from various wood handling processes such as furniture, flooring, or building production processes. The wood fibers may be virgin fibers. The lignocellulosic materials may also be one or more of hemp, grass, flax, straw and/or bagasse.

The backing layer may comprise 0-60% by weight of lignocellulosic materials.

The backing layer may comprise 0-90% by weight of inorganic fillers, such as calcium carbonate, barium sulphate and/or silicon dioxide.

The backing layer may comprise 5-100% by weight of NAF binder, such as 20-100% by weight or 50-100% by weight.

The backing layer may comprise less than 50% by weight, such as less than 10% by weight or less than 5% by weight of formaldehyde or a formaldehyde-comprising composition

The backing layer may be substantially free from formaldehyde.

The backing layer may be substantially free from melamine.

The backing layer may be configured to form a moisture barrier. A backing layer configured to form a moisture barrier may comprise e.g. a thin layer such as a lacquer, a varnish, an adhesive, a polymer-based sheet or foil, an impregnated paper or a powder layer.

The building panel may not comprise any backing or balancing layer.

The substrate may be a wood-based board, such as an MDF board, a HDF board, a plywood, or a particle board.

Alternatively, the substrate may be a thermoplastic core, such as a filled thermoplastic core, such as a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel).

The substrate may be a mineral-based board, such as a board comprising magnesium oxide. The substrate may be a fiber-cement board, a gypsum board or the like.

According to one alternative, the paper layer or the surface may be configured to form an outer surface of the finished building panel and the backing layer may be configured to form an inner or back surface of the finished building panel. The building panel may for example be a double-sided furniture component, such as a cabinet panel.

Another objective of embodiments of the present disclosure is to provide a building panel that fulfils the requirements to be classified as a laminate according to EN13329.

Another objective of embodiments of the present disclosure is to provide a building panel that fulfils the requirements to be classified as a modular mechanical locked floor covering (MMF) according to EN16511.

The building panel may be classified as a laminate panel according to EN13329.

The building panel may be classified as a modular mechanical locked floor covering (MMF) according to EN16511.

### BRIEF DESCRIPTION OF THE DRAWINGS

The present disclosure will by way of example be described in more detail with reference to the appended schematic drawings, which show embodiments of the present disclosure.

FIG. 1 shows a method for producing a building panel according to an embodiment of the present disclosure.

FIG. 2 shows a method for producing a building panel according to another embodiment of the present disclosure.

FIG. 3 shows a step of a method of producing a building panel according to embodiments of the present disclosure.

FIG. 4 shows a step of a method of producing a building panel according to embodiments of the present disclosure.

FIG. 5 is a building panel according to an embodiment of the present disclosure.

FIG. 6 is a building panel according to another embodiment of the present disclosure.

FIG. 7 shows a cross-sectional side view of a building panel according to an embodiment of the present disclosure.

FIG. 8 is an illustration of a top view of a building panel with a mechanical locking device, according to an embodiment of the present disclosure.

FIG. 9 is an illustration of a cross section of a mechanical locking device in an assembled state arranged along opposite edges of two adjacent building panels, according to an embodiment of the present disclosure.

Further, in the figures like reference characters designate like or corresponding parts throughout the several figures.

### DETAILED DESCRIPTION OF EMBODIMENTS

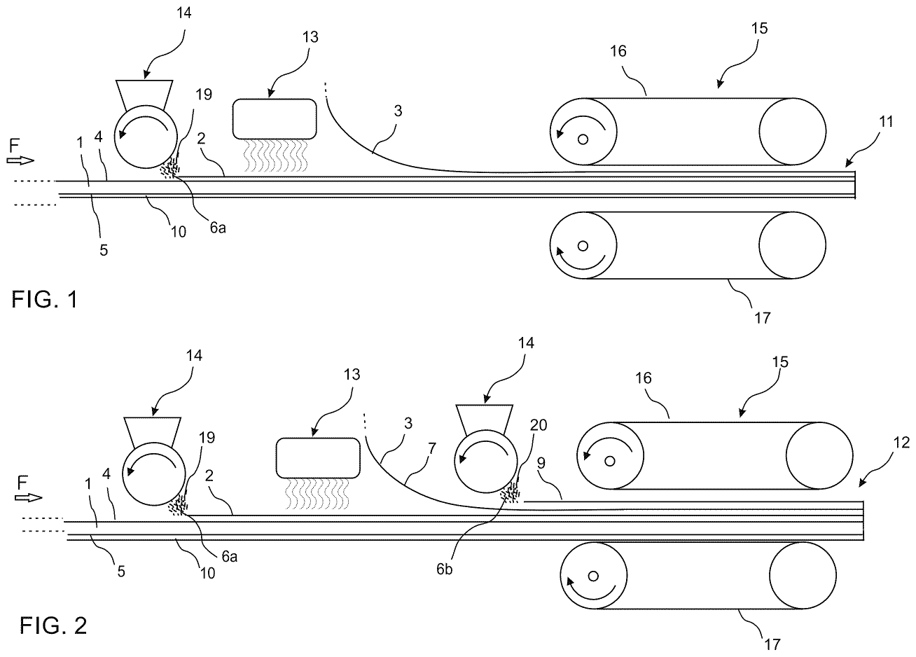

FIG. 1 illustrates an embodiment of a method for producing a building panel 11.

The building panel 11 may be, or form part of, a furniture component, a building panel such as a floor panel, a ceiling panel, a wall panel, a door panel, a worktop, skirting boards, moldings, edging profiles, etc.

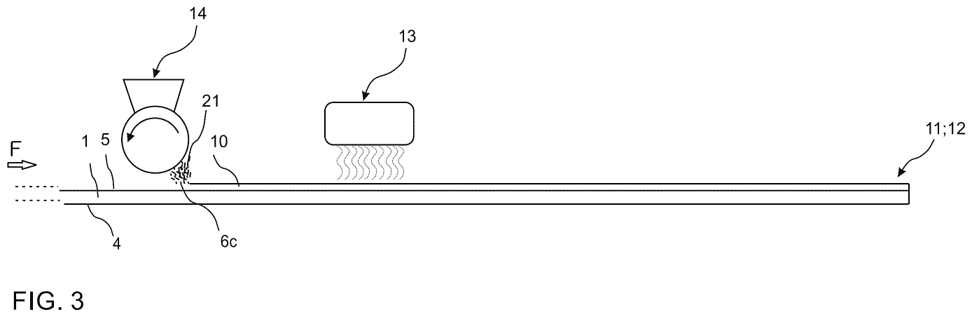

The method includes providing a substrate 1. The substrate 1 is moved in a direction F through a production line comprising several steps, which will be further described below with reference to FIG. 1 and FIG. 3.

The substrate 1 is preferably a prefabricated substrate, produced prior to the method of producing the panel 11. The substrate 1 may be a board, for example, a wood-based board. The wood-based board may be an MDF board, a HDF board, a plywood, a particle board or any other suitable wood-based board.

Alternatively, the substrate 1 may be a thermoplastic board, such as a filled thermoplastic board, such as a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel).

The substrate 1 may be a mineral-based board, such as a board comprising magnesium oxide. The substrate 1 may be a fiber-cement board, a gypsum board, a textile-based board or the like. The substrate 1 may comprise a combination of different materials. Boards comprising other materials may also be used.

A sub-layer 2 comprising a thermosetting, no added formaldehyde (NAF) binder 6a is applied on the front surface 4 of the substrate 1. In the embodiment shown in FIG. 1, the sub-layer 2 is applied in powder form, as a sub-layer powder 19, by scattering by means of a scattering device 14.

The sub-layer 2 may alternatively be applied as a granulate, as a sheet, preferably as an impregnated and/or coated sheet, such as an impregnated and/or coated paper, as a film, as a foil and/or in liquid form The NAF binder 6a of the sub-layer 2 may comprise one or more of polyester, unsaturated polyester, epoxy, polyurethane, acrylate, natural polymers such as lignin, or a combination thereof. The sub-layer 2 may have a moisture content of less than 5% by weight, such as less than 3% by weight, less than 2% by weight or 0-3% by weight, when applied on the front surface 4 of the substrate 1. The sub-layer 2 may have a moisture content exceeding 0% by weight and not exceeding 5% by weight, such as between 0.1% by weight and 5% weight, or between 0.1% by weight and 3% by weight, when applied on the front surface 4 of the substrate 1.

The method may comprise a step of applying heat by means of a heating device 13 to the sub-layer 2 as shown in FIG. 1. The heat may be applied by any suitable type of heat source e.g. thermal radiation, such as IR radiation, and/or by microwaves, and/or by hot air. The sub-layer 2 may be heated without first applying moisture to the sub-layer 2 or moisture may be applied to the sub-layer 2 prior to applying heat to the sub-layer 2. The step of heating the sub-layer 2 serves to sinter particles of the binder in the sub-layer 2. For example, the sintered particles may form a contiguous mass. For example, the sintered particles of the sub-layer 2 may adhere to the substrate 1.

After applying the sub-layer 2, a paper layer 3 is applied on the sub-layer 2. The paper-layer 3 is essentially unimpregnated when applied on the sub-layer 2.

After the paper layer 3 has been applied, heat and pressure are applied to the paper layer 3, the sub-layer 2 and the substrate 1, thereby at least partially curing the NAF binder 6a of the sub-layer 2.

Heat and pressure may be applied by a continuous press as shown in FIG. 1 or by a static press (not illustrated). As shown in the FIG. 1, the pressure may be applied by a continuous press 15, having an upper press belt 16 and a lower press belt 17. The pressure applied may be at least 5 bar, such as at least 25 bar, preferably about 30-60 bar, or about 35-55 bar. The pressure may be applied during at least 10 s, preferably during 20-40 s. The press 15 comprising e.g. either hot oil or electrical/induction heat is heated in order to apply heat together with pressure. A temperature of 100-250° C., such as 180-220° C., may be applied. A temperature of at least 150° C., such as at least 180° C., may be applied. The temperature may depend on which binder is used. Also, the temperature may depend on the speed of the production line in a continuous press or the press time of a static press.

When applying heat and pressure, the thermosetting, NAF binder 6a of the sub-layer 2 is at least partially cured to form a building panel 11. The thermosetting, NAF binder 6a of the sub-layer may be at least partially cross-linked.

The step of applying heat and pressure to the paper layer 3, the sub-layer 2 and the substrate 1 may comprise at least partially impregnating the paper layer 3 with the NAF binder 6a of the sub-layer 2. The paper layer 3 may be fully impregnated with the NAF binder 6a of the sub-layer 2. The impregnation of the paper layer 3 occurring during the step of applying heat and pressure may be satisfactory, so that no further layer is required to be applied on the paper layer 3. The paper layer 3 may form an upper surface of the finished building panel 11.

A backing layer 10 may be applied to a back surface 5 of the substrate 1, opposite the first surface 4 on which the front layer 2 is applied, thereby forming a backing layer 10, as shown in FIG. 3. For practical reasons, the backing layer 10 is preferably applied to the back surface 5 of the substrate 1 in a step occurring before the application of the sub-layer 2. Heat and optionally also moisture may be applied to the backing layer 10 to sinter the particles of the backing layer 10. When the backing layer 10 has been applied to the substrate 1, the substrate 1 and the backing layer 10 are turned, whereafter the sub-layer 2 is applied on the first surface 4 of the substrate 1, as illustrated in FIG. 1. Turning the substrate 1 and the backing layer 10 is preferably done automatically.

The backing layer 10 may comprise a thermosetting, no added formaldehyde (NAF) binder 6c. In the embodiment shown in FIG. 3, the backing layer 10 is applied in powder form, as a backing layer powder 21, by scattering by means of a scattering device 14.

The backing layer 10 may alternatively be applied as a granulate, as a sheet, preferably as an impregnated and/or coated sheet, such as an impregnated and/or coated paper, as a film, as a foil and/or in liquid form. The NAF binder 6c of the backing layer 10 may comprise one or more of polyester, unsaturated polyester, epoxy, polyurethane, acrylate, natural polymers such as lignin, or a combination thereof. The backing layer 10 may have a moisture content of less than 5% by weight, such as less than 3% by weight, less than 2% by weight or 0-3% by weight, when applied on the back surface 5 of the substrate 1. The backing layer 10 may have a moisture content exceeding 0% by weight and not exceeding 5% by weight, such as between 0.1% by weight and 5% weight, or between 0.1% by weight and 3% by weight, when applied on the back surface 5 of the substrate 1.

A backing layer 10 may be applied to a back surface 5 of the substrate 1 in order to form a balancing layer. However, as a NAF binder 6a, a binder not comprising added formaldehyde, is used in the sub-layer 2, there may not be a need for such a balancing or backing layer. Possible contraction forces due to the sub-layer may be too small to require balance in the form of a balancing or backing layer. The building panel 11 may be made without any backing layer.

However, a backing layer 10 may be applied to a back surface 5 of the substrate 1 to form a moisture barrier. A backing layer 10 configured to form a moisture barrier may comprise e.g. a thin layer such as a lacquer, a varnish, an adhesive, a polymer-based sheet or foil, an impregnated paper or a (colored) powder layer.

If a backing layer 10 is applied to a back surface 5 of the substrate 1, heat and pressure is applied to the paper layer 3, the sub-layer 2, the substrate 1 and the backing layer 10 to form a building panel 11.

FIG. 2 illustrates another embodiment of a method for producing a building panel 12.

The building panel 12 may be, or form part of, a furniture component, a building panel such as a floor panel, a ceiling panel, a wall panel, a door panel, a worktop, skirting boards, moldings, edging profiles, etc.

The method includes providing a substrate 1. The substrate 1 is moved in a direction F through a production line comprising several steps, which will be further described below with reference to FIG. 2 and FIG. 3.

The substrate 1 is preferably a prefabricated substrate, produced prior to the method of producing the panel 12. The substrate 1 may be a board, for example, a wood-based board. The wood-based board may be an MDF board, a HDF board, a plywood, a particle board or any other suitable wood-based board. Alternatively, the substrate 1 may be a thermoplastic board, such as a filled thermoplastic board, such as a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel).

The substrate 1 may be a mineral-based board, such as a board comprising magnesium oxide. The substrate 1 may be a fiber-cement board, a gypsum board, a textile-based board or the like. The substrate 1 may comprise a combination of different materials. Boards comprising other materials may also be used.

A sub-layer 2 comprising a thermosetting, no added formaldehyde (NAF) binder 6a is applied on the front surface 4 of the substrate 1. In the embodiment shown in FIG. 2, the sub-layer 2 is applied in powder form, as a sub-layer powder 19, by scattering by means of a scattering device 14.

The sub-layer 2 may alternatively be applied as a granulate, as a sheet, preferably as an impregnated and/or coated sheet, such as an impregnated and/or coated paper, as a film, as a foil and/or in liquid form. The NAF binder 6a of the sub-layer 2 may comprise one or more of polyester, unsaturated polyester, epoxy, polyurethane, acrylate, natural polymers such as lignin, or a combination thereof. The sub-layer 2 may have a moisture content of less than 5% by weight, such as less than 3% by weight, less than 2% by weight or 0-3% by weight, when applied on the front surface 4 of the substrate 1. The sub-layer 2 may have a moisture content exceeding 0% by weight and not exceeding 5% by weight, such as between 0.1% by weight and 5% weight, or between 0.1% by weight and 3% by weight, when applied on the front surface 4 of the substrate 1.

The method may comprise a step of applying heat by means of a heating device 13 to the sub-layer 2 as shown in FIG. 2. The heat may be applied by any suitable type of heat source e.g. thermal radiation, such as IR radiation, and/or by microwaves, and/or by hot air. The sub-layer 2 may be heated without first applying moisture to the sub-layer 2 or moisture may be applied to the sub-layer 2 prior to applying heat to the sub-layer 2. The step of heating the sub-layer 2 serves to sinter particles of the binder in the sub-layer 2. For example, the sintered particles may form a contiguous mass. For example, the sintered particles of the sub-layer 2 may adhere to the substrate 1.

After applying the sub-layer 2, a paper layer 3 is applied on the sub-layer 2. The paper-layer 3 is essentially unimpregnated when applied on the sub-layer 2.

After the paper-layer 3 has been applied, a surface layer 9 is applied on a front surface 7 of the paper layer 3. The surface layer 9 may comprise a thermosetting, no added formaldehyde (NAF) binder 6b. In the embodiment shown in FIG. 2, the surface layer 9 is applied in powder form, as a surface layer powder 20, by scattering by means of a scattering device 14.

The surface layer 9 may alternatively be applied as a granulate, as a sheet, preferably as an impregnated and/or coated sheet, such as an impregnated and/or coated paper, as a film, as a foil and/or in liquid form. The NAF binder 6b of the surface layer 9 may comprise one or more of polyester, unsaturated polyester, epoxy, polyurethane, acrylate, natural polymers such as lignin, or a combination thereof. The surface layer 9 may have a moisture content of less than 5% by weight, such as less than 3% by weight, less than 2% by weight or 0-3% by weight, when applied on the front surface 7 of the paper layer 3. The surface layer 9 may have a moisture content exceeding 0% by weight and not exceeding 5% by weight, such as between 0.1% by weight and 5% weight, or between 0.1% by weight and 3% by weight, when applied on the front surface 7 of the paper layer 3.

After the surface layer 9 has been applied, heat and pressure are applied to the surface layer 9, the paper layer 3, the sub-layer 2 and the substrate 1, thereby at least partially curing the NAF binder 6a of the sub-layer 2 and the binder of the surface layer.

Heat and pressure may be applied by a continuous press as shown in FIG. 2 or by a static press (not illustrated). As shown in the FIG. 2, the pressure may be applied by a continuous press 15, having an upper press belt 16 and a lower press belt 17. The pressure applied may be at least 5 bar, such as at least 25 bar, preferably about 30-60 bar, or about 35-55 bar. The pressure may be applied during at least 10 s, preferably during 20-40 s. The press 15 comprising e.g. either hot oil or electrical/induction heat is heated in order to apply heat together with pressure. A temperature of 100-250° C., such as 180-220° C., may be applied. A temperature of at least 150° C., such as at least 180° C., may be applied. The temperature may depend on which binder is used. Also, the temperature may depend on the speed of the production line in a continuous press or the press time of a static press.

When applying heat and pressure, the thermosetting, NAF binder 6a of the sub-layer 2 and the binder of the surface layer 9 are at least partially cured to form a building panel 12. The thermosetting, NAF binder 6a of the sub-layer and the binder of the surface layer 9 may be at least partially cross-linked.

The step of applying heat and pressure to the surface layer 9, the paper layer 3, the sub-layer 2 and the substrate 1 comprises at least partially impregnating the paper layer 3 with the NAF binder 6a of the sub-layer 2. The step of applying heat and pressure to the surface layer 9, the paper layer 3, the sub-layer 2 and the substrate 1 comprises at least partially impregnating the paper layer 3 with the binder of the surface layer 9. The surface layer 9 may form an upper surface of the finished building panel 12.

A backing layer 10 may be applied to a back surface 5 of the substrate 1, opposite the first surface 4 on which the front layer 2 is applied, thereby forming a backing layer 10, as shown in FIG. 3. For practical reasons, the backing layer 10 is preferably applied to the back surface 5 of the substrate 1 in a step occurring before the application of the sub-layer 2. Heat and optionally also moisture may be applied to the backing layer 10 to sinter the particles of the backing layer 10. When the backing layer 10 has been applied to the substrate 1, the substrate 1 and the backing layer 10 are turned, whereafter the sub-layer 2 is applied on the first surface 4 of the substrate 1, as illustrated in FIG. 2. Turning the substrate 1 and the backing layer 10 is preferably done automatically.

The backing layer 10 may comprise a thermosetting, no added formaldehyde (NAF) binder 6c. In the embodiment shown in FIG. 3, the backing layer 10 is applied in powder form, as a backing layer powder 21, by scattering by means of a scattering device 14.

The backing layer 10 may alternatively be applied as a granulate, as a sheet, preferably as an impregnated and/or coated sheet, such as an impregnated and/or coated paper, as a film, as a foil and/or in liquid form. The NAF binder 6c of the backing layer 10 may comprise one or more of polyester, unsaturated polyester, epoxy, polyurethane, acrylate, natural polymers such as lignin, or a combination thereof. The backing layer 10 may have a moisture content of less than 5% by weight, such as less than 3% by weight, less than 2% by weight or 0-3% by weight, when applied on the back surface 5 of the substrate 1. The backing layer 10 may have a moisture content exceeding 0% by weight and not exceeding 5% by weight, such as between 0.1% by weight and 5% weight, or between 0.1% by weight and 3% by weight, when applied on the back surface 5 of the substrate 1.

A backing layer 10 may be applied to a back surface 5 of the substrate 1 in order to form a balancing layer. However, as a NAF binder 6a, a binder not comprising added formaldehyde, is used in the sub-layer 2, there may not be a need for such a balancing or backing layer. The surface layer 9 preferably also comprises a NAF binder 6b. Possible contraction forces due to the sub-layer and the surface layer may be too small to require balance in the form of a balancing or backing layer. The building panel 12 may be made without any backing layer.

However, a backing layer 10 may be applied to a back surface 5 of the substrate 1 to form a moisture barrier. A backing layer 10 configured to form a moisture barrier may comprise e.g. a thin layer such as a lacquer, a varnish, an adhesive, a polymer-based sheet or foil, an impregnated paper or a (colored) powder layer.

If a backing layer 10 is applied to a back surface 5 of the substrate 1, heat and pressure is applied to the surface layer 9, the paper layer 3, the sub-layer 2, the substrate 1 and the backing layer 10 to form a building panel 12.

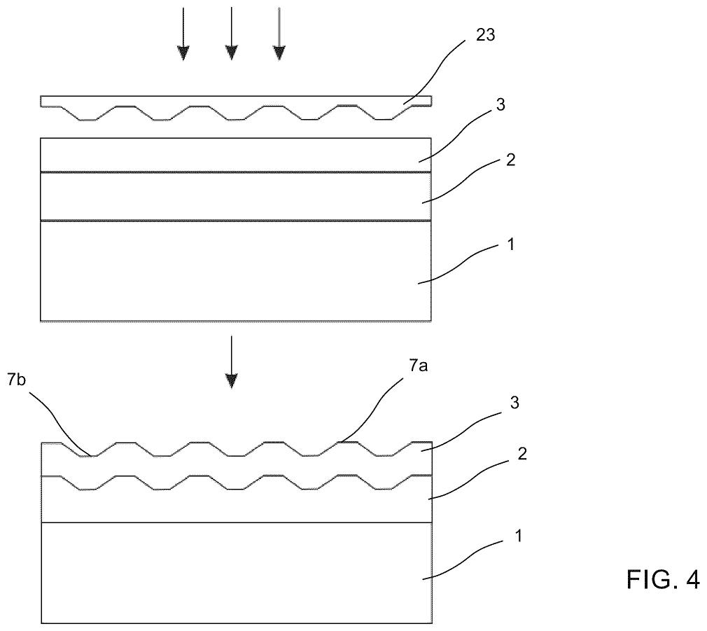

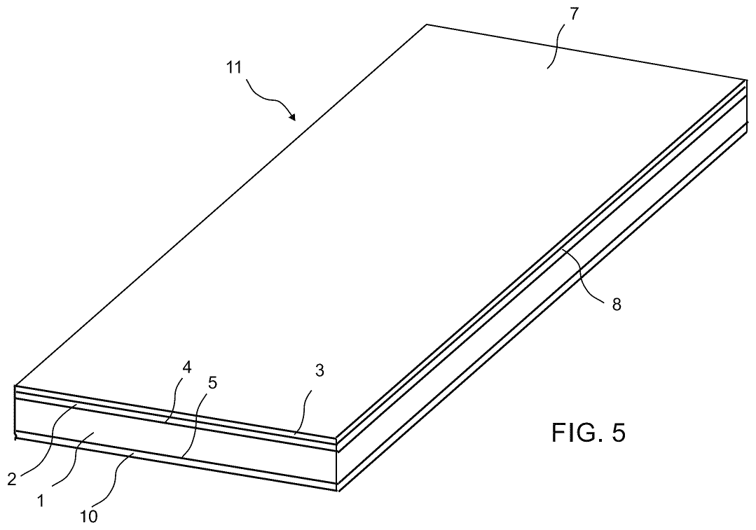

The step of applying heat and pressure may further comprise a step of pressing the paper layer 3 with an embossed pressing matrix 23, such that the paper layer 3 obtains upper portions 7a and embossed portions 7b, lower than the upper portions, essentially by shaping of the sub-layer 2. The paper layer 3 may be pressed with the embossed pressing matrix 23 by at least 0.1 mm, such as at least 0.2 mm or at least 0.5 mm. The method may comprise pressing the paper layer 3 by 0.1-1.0 mm, such as 0.1-0.8 mm or 0.1-0.7 mm. This step is illustrated in FIG. 4.

If a surface layer 9 has been applied, the step of applying heat and pressure may further comprise pressing the surface layer 9 with an embossed pressing matrix 23, such that the surface layer 9 obtains upper portions and embossed portions, lower than the upper portions, essentially by shaping of the surface layer 9 and/or the sub-layer 2 (not illustrated). The step of pressing the surface layer 9 with the embossed pressing matrix 23 may be by at least 0.1 mm, such as at least 0.2 mm or at least 0.5 mm. The method may comprise pressing the surface layer 9 by 0.1-1.0 mm, such as 0.1-0.8 mm or 0.1-0.7 mm.

The embossed pressing matrix 23 may refer to an embossing pressing matrix. The embossed pressing matrix 23 as well as the embossing matrix may provide an embossed surface.

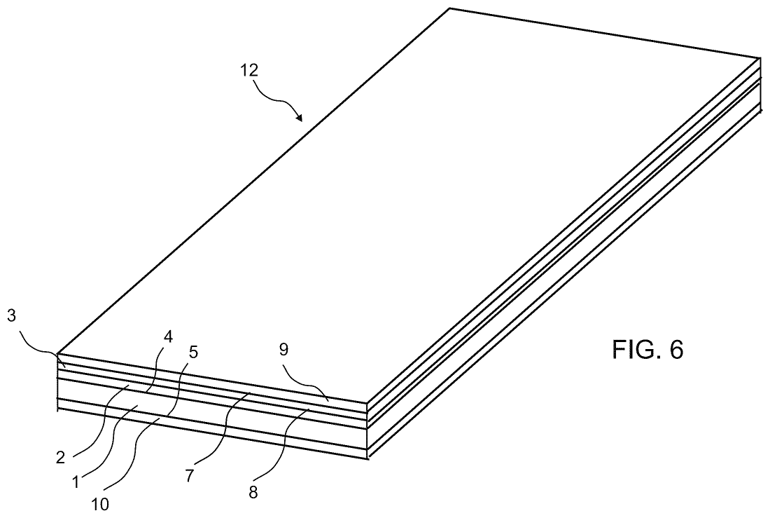

After pressing, a building panel is formed. The building panel includes a substrate 1, a sub-layer 2, a paper layer 3, optionally a surface layer 9 and optionally a backing layer 10. Different types of pressed building panels 11 and 12 are schematically illustrated in FIGS. 5 and 6 respectively.

The building panels 11 and 12 may be processed from a larger panel board (not illustrated), e.g. by cutting the larger panel board into individual building panels.

The building panels 11 and 12 may be provided with a mechanical locking system.

The building panels 11 and 12 may be a floor panel, a furniture component, a worktop, a wall panel, a ceiling panel or similar.

The building panels 11 and 12 may be classified as a laminate panel according to EN13329:2024.

The building panels 11 and 12 may be classified as a modular mechanical locked floor covering (MMF) according to EN16511.

FIG. 5 shows a building panel 11 comprising a substrate 1, a sub-layer 2 arranged on a front surface 4 of the substrate 1 and a paper layer 3 attached to the sub-layer 2. The sub-layer 2 comprises a thermosetting, no added formaldehyde (NAF) binder 6a and the paper layer 3 has been at least partially impregnated with the NAF binder 6a of the sub-layer.

The building panel 11 may additionally comprise a backing layer 10, arranged on a back surface 5 of the substrate 1, opposite from the first surface 4 on which the sub-layer 2 is arranged. The backing layer 10 may comprise a NAF binder 6c.

FIG. 6 shows a building panel 12 comprising a substrate 1, a sub-layer 2 arranged on a front surface 4 of the substrate 1, a paper layer 3 attached to the sub-layer 2 and a surface layer 9 arranged on a front surface 7 of the paper layer 3. The sub-layer 2 comprises a thermosetting, no added formaldehyde (NAF) binder 6a and the paper layer 3 has been at least partially impregnated with the NAF binder 6a of the sub-layer. The surface layer 9 may comprise a no added formaldehyde NAF binder 6b.

The building panel 12 may additionally comprise a backing layer 10, arranged on a back surface 5 of the substrate 1, opposite from the first surface 4 on which the sub-layer 2 is arranged. The backing layer 10 may comprise a NAF binder 6c.

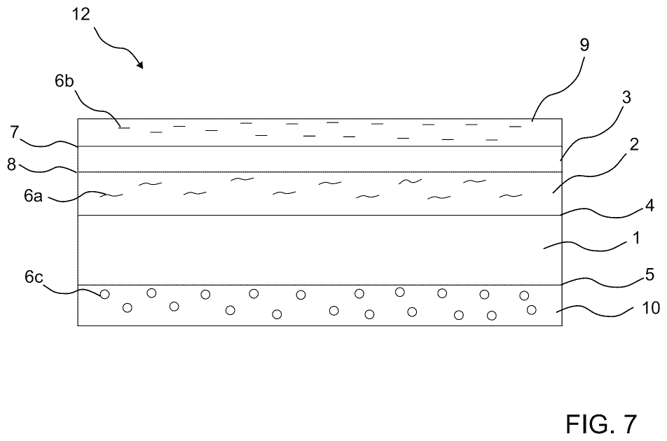

FIG. 7 shows a cross-sectional side view of a building panel 12 comprising a substrate 1, a sub-layer 2 arranged on a front surface 4 of the substrate 1, a paper layer 3 attached to the sub-layer 2 and a surface layer 9 arranged on a front surface 7 of the paper layer 3. The sub-layer 2 comprises a thermosetting, no added formaldehyde (NAF) binder 6a and the paper layer 3 has been at least partially impregnated with the NAF binder 6a of the sub-layer. The surface layer 9 may comprise a no added formaldehyde NAF binder 6b.

The building panel 12 may additionally comprise a backing layer 10, arranged on a back surface 5 of the substrate 1, opposite from the first surface 4 on which the sub-layer 2 is arranged. The backing layer 10 may comprise a NAF binder 6c.

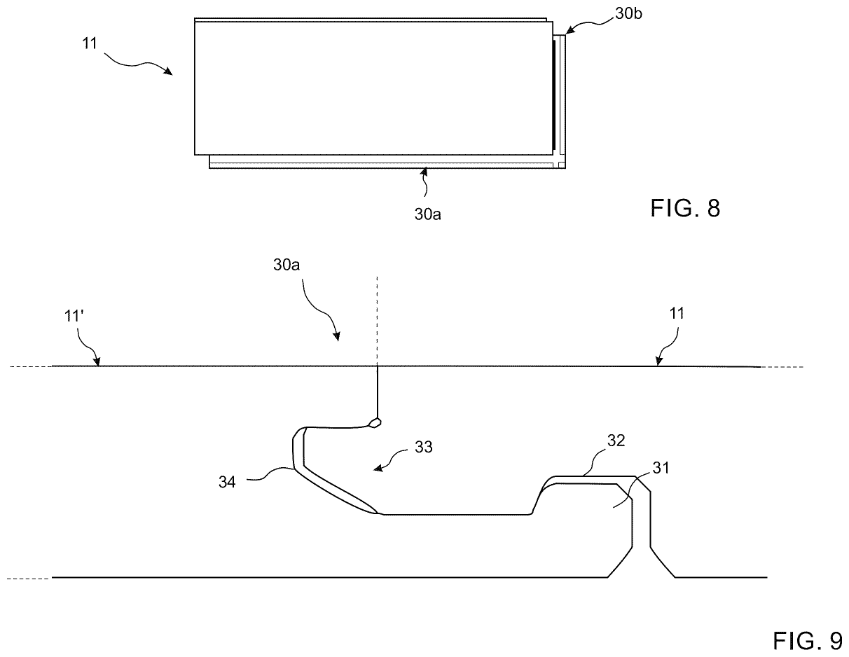

FIG. 8 illustrates a top view of a building panel 11 provided with a first mechanical locking device 30a and a second mechanical locking device 30b, in order to assemble similar or essentially identical building panels.

FIG. 9 is a schematic illustration of the first mechanical locking device 30a in the assembled state of two adjacent building panels 11, 101. The first mechanical locking device 30a comprises a locking element 31, configured to cooperate with a locking groove 32 for horizontal locking.

The first mechanical locking device 30a further comprises a locking tongue 33, configured to cooperate with a tongue groove 34 for vertical locking.

The embodiments have been described in relation to a continuous press 15 having an upper press belt 16 and a lower press belt 17. In other embodiments, a static press may be used. A static press comprises an upper press plate and a lower press plate. The invention is further illustrated in the following examples, which do not limit the scope of the invention described in the claims.

### EXAMPLES

Compositions A and B used in the below Examples are specified in Table 1 below.

TABLE 1
Compositions used in the Examples.

| | Composition | Composition |
|---|---|---|
| Component | A (wt %) | B (wt %) |
| Polyester-based NAF resin | 80 | 0 |
| Melamine-formaldehyde resin | 0 | 80 |
| Wear resistant particles | 20 | 20 |

### Example 1. (According to the Invention) Production of Building Panel with Powder Sub-Layer, Unimpregnated Paper Layer and Powder Surface Layer, NAF Binder

A sub-layer of composition A was applied as a powder on a HDF panel in an amount of 30 g/m². IR-heating was applied to fasten the powder onto the panel surface. An unimpregnated décor paper was applied with the rear side facing the sub-layer. A surface layer of composition A was applied as a powder on the décor side of the unimpregnated paper in an amount of 190 g/m². IR-heating was applied on the surface layer. A plastic-coated paper was applied on the back side of the HDF panel. The specimen was heat pressed at 180° C. and 50 bar for 30 s. A laminated building panel with a surface coating of the polyester-based NAF binder was formed.

### Example 2. (Comparative) Production of Building Panel with Powder Sub-Layer, Unimpregnated Paper Layer and Powder Surface Layer, Melamine-Formaldehyde Binder

A sub-layer of composition B was applied as a powder on a HDF panel in an amount of 30 g/m². The powder surface was treated with a water mist and IR-heating in order to fasten the powder layer onto the panel surface. An unimpregnated décor paper was applied with the rear side facing the sub-layer. A surface layer of composition B was applied as a powder on the décor side of the unimpregnated paper in an amount of 150 g/m². A water mist and IR-heating was applied on the surface layer. A plastic-coated paper was applied on the back side of the HDF panel. The specimen was heat pressed at 180° C. and 50 bar for 30 s. A laminated building panel with a surface coating of the melamine-formaldehyde binder was formed.

The amounts of powder applied in the sub-layer and the surface-layer respectively, in Example 1 and Example 2, were chosen so as to achieve sub-layers and surface layers that were as equal as possible respectively, with respect to applied volume, in Example 1 and Example 2.

### Example 3. (Comparative) Production of Building Panel: Direct Pressure Laminate, Melamine-Formaldehyde Impregnated Papers

A melamine-formaldehyde impregnated décor paper was applied on a HDF panel, and a melamine-formaldehyde impregnated overlay paper was applied on the décor paper. The papers were specified for classification of use in class 23/32 according to EN13329. A melamine-formaldehyde impregnated balancing paper was applied on the rear side. The specimen was heat pressed at 180° C. and 50 bar for 30 s. A laminated building panel was formed.

### Example 4. Surface Impact Measurements (Big Ball)

Surface impact tests were performed on the building panels produced in Example 1 and Example 2 respectively. The impact tests were performed in accordance with EN13329:2024 (Big ball). A maximum drop height of 1900 mm was tested for the two building panels. Drop height (without forming cracks) for Class 34 is ≥1600 mm. The results are shown in Table 2 below.

TABLE 2

| | Max diameter | Panel |
|---|---|---|
| Panel | of impact (mm) | appearance |
| Example 1 (NAF binder) | 9.50 | No cracks |
| Example 2 (Melamine- | 9.55 | No cracks |
| formaldehyde binder) | | |

As can be seen in Table 2, the panel produced in Example 1, produced according to the method of the present invention, performs at least equally well as the panel of Example 2, produced with a conventional melamine-formaldehyde binder.

### Example 5. Surface Impact Measurements (Small Ball)

Surface impact tests were performed on the building panels produced in Example 1, Example 2 and Example 3. The impact tests were performed in accordance with EN13329:2024 (Small ball). Drop height was varied for every sample in the series in order to reveal at which drop heigh cracks were formed. Drop height (without forming cracks) for Class 33 is ≥70 mm. The results are shown in Table 3 below.

TABLE 3

| | Drop height | Panel |
|---|---|---|
| Panel | (cm) | appearance |
| Example 1 (NAF binder) | ≤150 | No cracks |
| Example 1 (NAF binder) | 160 | Cracks |
| Example 2 (Melamine- | ≤100 | No cracks |
| formaldehyde binder) | | |
| Example 2 (Melamine- | 110 | Cracks |
| formaldehyde binder) | | |
| Example 3 (Direct | ≤40 | No cracks |
| Pressure Laminate) | | |
| Example 3 (Direct | 50 | Cracks |
| Pressure Laminate) | | |

As can be seen in Table 3, the panel produced in Example 1, according to the method of the present invention, clearly is the most impact resistant, according to EN13329:2024, of the three tested panels.

### Example 6. Wear Resistance Measurements

Wear resistance tests were performed on the building panel produced in Example 1. The tests were performed in accordance with EN13329:2024 (ISO 24338 (2022) Procedure A). The result of the wear resistance test was 7300 revolutions at failure. The requirement for class 33 of EN13329:2024 is ≥6000 revolutions before failure. Thus, the requirement for class 33 of EN13329:2024 were met.

### Example 7. Thickness Swelling Measurements

Thickness swelling measurements were performed on the building panel produced in Example 1. The tests were performed in accordance with EN13329:2024 (ISO 24338 (2022)). The result of the thickness swelling measurements was 14.7%. The requirement for class 33 of EN13329:2024 is ≤15%. Thus, the requirement for class 33 of EN13329:2024 were met.

### Example 8. Surface Soundness Measurements

Surface soundness measurements were performed on the building panel produced in Example 1. The tests were performed in accordance with EN13329:2024 (ISO 24338 (2022)). The result of the surface soundness measurements was 1.94 N/mm². In addition, failure mode of the test was within the underlying board (substrate), which is the desired mode of failure. The requirement for class 34 of EN13329:2024 is ≥1.5 N/mm². Thus, the requirement for class 34 of EN13329:2024 were met.

The building panel produced in Example 1, with the method according to the present invention, thus meets the requirements to be classified as a laminate panel according to EN13329, for all the tested parameters.

### Example 9. Production of Building Panels with Powder Sub-Layer, Unimpregnated Paper Layer and Powder Surface Layer, NAF Binder; Comparison of Different Moisture Contents of the Applied Powders

Composition A, comprising the components specified above in Table 1, was used in this Example. Three different building panels were produced using the following method: Approximately 50 g/m² of Composition A was uniformly scattered onto an HDF substrate, forming a sub-layer. The sub-layer was pre-treated according to three different methods, as specified in Table 4 below. An unimpregnated décor paper was placed on top of the sub-layer. Approximately 120 g/m² of Composition A was uniformly scattered over the décor paper, forming a surface layer. The surface layer was pre-treated with the same method as the sub-layer. A sample of the treated powder in the surface layer was taken, and the moisture content of the sample was measured gravimetrically (using an IR-heating device, a moisture content measuring device with a quartz-halogen lamp and a drying temperature of 120° C.). The assembly was heat pressed at 170° C., 40 bar, for 30 seconds.

TABLE 4

| | | Moisture | |
|---|---|---|---|
| | Pre-treatment | content | Appearance of pressed |
| Sample | method | (wt %) | building panel |
| 1 | Infrared (IR) heating | 1.2 | Clear surface, no blister |
| | | | formation observed |
| 2 | Water mist followed | 6.1 | Severe blister formation |
| | by IR heat | | between paper and |
| | | | substrate |
| 3 | Water mist followed | 8.7 | Severe blister formation |
| | by IR heat | | between paper and |
| | | | substrate |

The results demonstrate a strong correlation between the moisture content of the powder layers and the quality of the final laminate. Specifically, elevated moisture levels (>6 wt %) significantly increase the risk of blister formation between the décor paper and the HDF substrate. Therefore, precise control of moisture content is critical to achieving a defect-free laminate surface.

### ITEMS

1. A method for producing a building panel comprising:
providing a substrate (1),
applying a sub-layer (2) comprising a no added formaldehyde (NAF) binder (6a) on a front surface (4) of the substrate (1), wherein said NAF binder (6a) is a thermosetting binder, applying a paper layer (3) on the sub-layer (2), wherein said paper layer (3) is essentially unimpregnated when applied on said sub-layer (2), and
thereafter applying heat and pressure to the paper layer (3), the sub-layer (2) and the substrate (1), thereby at least partially curing the NAF binder (6a) of the sub-layer (2), to form said building panel.
2. The method according to item 1, wherein the step of applying heat and pressure to the paper layer (3), the sub-layer (2) and the substrate (1) comprises at least partially impregnating the paper layer (3) with said NAF binder (6a).
3. The method according to item 1 or 2, wherein the method further comprises the step of pressing the paper layer (3) with an embossed pressing matrix (23), such that the paper layer (3) obtains upper portions (7a) and embossed portions (7b), lower than the upper portions, essentially by shaping of the sub-layer (2).
4. The method according to item 3, further comprising pressing the paper layer (3) by at least 0.1 mm, such as at least 0.2 mm or at least 0.5 mm.
5. The method according to any of the preceding items, wherein the NAF binder (6a) of the sub-layer (2) comprises one or more of polyester, unsaturated polyester, epoxy, polyurethane, acrylate, natural polymers such as lignin, or a combination thereof.
6. The method according to any of the preceding items, wherein the sub-layer (2) is applied in powder form or as a granulate.
7. The method according to any of the preceding items, wherein the sub-layer (2) is applied in an amount of 10-1000 g/m².
8. The method according to any of the preceding items, additionally comprising applying a surface layer (9) on a front surface (7) of the paper layer (3), and
thereafter applying heat and pressure to the surface layer (9), the paper layer (3), the sub-layer (2) and the substrate (1), thereby at least partially curing the surface layer (9) and the sub-layer (2) to form said building panel.
9. The method according to item 8, wherein the surface layer (9) comprises a no added formaldehyde (NAF) binder (6b).
10. The method according to item 8 or 9, wherein the surface layer (9) is applied in powder form, or as a granulate.
11 The method according to any of items 8-10, wherein the surface layer (9) is applied in an amount of 10-1000 g/m².
12 The method according to any of the preceding items, further comprising applying a backing layer (10) to a back surface (5) of the substrate (1) opposite the front surface (4) on which the sub-layer (2) is applied, and
thereafter applying heat and pressure to the surface layer (9), the paper layer (3), the sub-layer (2), the substrate (1) and the backing layer (10), thereby at least partially curing the surface layer (9), the sub-layer (2), and the backing layer to form said building panel.
13. The method according to item 12, wherein the backing layer (10) comprises a no added formaldehyde (NAF) binder (6c).
14. The method according to item 12 or 13, wherein the backing layer (10) is configured to form a moisture barrier.
15. The method according to any of the preceding items, wherein the sub-layer (2) and/or the surface layer (9) and/or the backing layer (10) comprises one or more of fillers, pigments, wear-resistant particles, lignocellulosic materials, and other additives.
16. The method according to any of the preceding items, wherein the substrate (1) is a wood-based board, such as an MDF board, a HDF board, a plywood, or a particle board.
17. The method according to any of the preceding items, wherein the temperature applied in the heating and pressing step is 100-250° C.
18. The method according to any of the preceding items, wherein the pressure applied in the heating and pressing step is at least 25 bar.
19. A building panel (12) produced with the method according to any of the items 1-18.
20. A building panel (12), comprising:
a substrate (1),
a sub-layer (2) attached to a front surface (4) of the substrate (1),
wherein the sub-layer (2) comprises a thermosetting, no added formaldehyde (NAF) binder (6a), and
a paper layer (3) attached to the sub-layer (2), wherein the paper layer (3) has been at least partially impregnated with the NAF binder (6a) of the sub-layer (2).
21. The building panel according to item 20, wherein the paper layer (3) comprises upper portions (7a) and embossed portions (7b) lower than the upper portions (7a).
22. The building panel according to item 20 or 21, wherein said building panel (12) additionally comprises a surface layer (9) arranged on a front surface (7) of the paper layer (3).
23. The building panel according to item 22, wherein the surface layer (9) comprises a no added formaldehyde (NAF) binder (6b).
24. The building panel according to any of the items 20-23, wherein said building panel (11; 12) additionally comprises a backing layer (10) arranged on a back surface (5) of the substrate (1), opposite from the first surface (4) on which the sub-layer (2) is arranged.
25. The building panel according to item 24, wherein the backing layer (10) comprises a no added formaldehyde (NAF) binder (6c).
26. The building panel according to item 24 or 25, wherein the backing layer (10) is configured to form a moisture barrier.
27. The building panel according to any of the items 19-26, wherein said building panel (11; 12) is classified as a laminate panel according to EN13329.

1. A method for producing a building panel comprising:
providing a substrate,
applying a sub-layer comprising a no added formaldehyde (NAF) binder on a front surface of the substrate, wherein said NAF binder is a thermosetting binder,
applying a paper layer on the sub-layer, wherein said paper layer is essentially unimpregnated when applied on said sub-layer, and
thereafter applying heat and pressure to the paper layer, the sub-layer and the substrate, thereby at least partially impregnating the paper layer with the NAF binder of the sub-layer and at least partially curing the NAF binder of the sub-layer, to form said building panel.

2. The method according to claim 1, wherein the step of applying heat and pressure further comprises pressing the paper layer with an embossed pressing matrix, such that the paper layer obtains upper portions and embossed portions, lower than the upper portions, essentially by shaping of the sub-layer.

3. The method according to claim 2, wherein the step of pressing the paper layer with the embossed pressing matrix is by at least 0.1 mm.

4. The method according to claim 1, wherein the NAF binder of the sub-layer comprises one or more of polyester, unsaturated polyester, epoxy, polyurethane, acrylate, natural polymers, or a combination thereof.

5. The method according to claim 1, wherein the sub-layer is applied as a powder, as a granulate, as a sheet, as a film, as a foil, and/or in liquid form.

6. The method according to claim 1, wherein the sub-layer is applied in an amount of 10-1000 g/m².

7. The method according to claim 1, further comprising applying a backing layer to a back surface of the substrate opposite the front surface on which the sub-layer is applied, and
thereafter applying heat and pressure to the paper layer, the sub-layer, the substrate and the backing layer, thereby at least partially curing the sub-layer and the backing layer to form said building panel.

8. The method according to claim 1, further comprising applying a surface layer on a front surface of the paper layer, and
thereafter applying heat and pressure to the surface layer, the paper layer, the sub-layer and the substrate, thereby at least partially curing the surface layer and the sub-layer to form said building panel.

9. The method according to claim 8, wherein the surface layer comprises a NAF binder.

10. The method according to claim 8, further comprising applying a backing layer to a back surface of the substrate opposite the front surface on which the sub-layer is applied, and
thereafter applying heat and pressure to the surface layer, the paper layer, the sub-layer, the substrate and the backing layer, thereby at least partially curing the surface layer, the sub-layer, and the backing layer to form said building panel.

11. The method according to claim 7, wherein the backing layer comprises a NAF binder.

12. The method according to claim 7, wherein the backing layer is configured to form a moisture barrier.

13. The method according to claim 8, wherein the sub-layer and/or the surface layer and/or the backing layer comprises one or more of fillers, pigments, wear-resistant particles, lignocellulosic materials, and other additives.

14. The method according to claim 1, wherein the substrate is a wood-based board.

15. A building panel, comprising:
a substrate,
a sub-layer attached to a front surface of the substrate,
wherein the sub-layer comprises a thermosetting, no added formaldehyde binder, and
a paper layer attached to the sub-layer, wherein the paper layer has been at least partially impregnated with the NAF binder of the sub-layer.

16. The building panel according to claim 15, wherein the paper layer is configured to form an upper surface of the building panel, facing upwards.

17. The building panel according to claim 15, wherein the paper layer comprises upper portions and embossed portions lower than the upper portions.

18. The building panel according to claim 15, wherein said building panel additionally comprises a surface layer arranged on a front surface of the paper layer.

19. The building panel according to claim 18, wherein the surface layer is configured to form an upper surface of the building panel, facing upwards.

20. The building panel according to claim 18, wherein the surface layer comprises a no added formaldehyde binder.

21. The building panel according to claim 15, wherein said building panel additionally comprises a backing layer arranged on a back surface of the substrate, opposite from the first surface on which the sub-layer is arranged.

22. The building panel according to claim 15, wherein said building panel is classified as a laminate panel according to EN13329.
